(19) United States
(12) Patent Application Publication
(10) Pub. No.: US 2024/0203609 A1
(43) Pub. Date: Jun. 20, 2024

(54) FUSION NUCLEAR REACTOR

(71) Applicant: Jacopo ZAMATTIO, Venezia (IT)

(72) Inventor: Jacopo ZAMATTIO, Venezia (IT)

(21) Appl. No.: 18/555,014

(22) PCT Filed: Apr. 19, 2022
(86) PCT No.: PCT/IB2022/053651

§ 371 Date: Oct. 12, 2023

(30) Foreign Application Priority Data
Apr. 16, 2021 (IT) 102021000009740
Apr. 21, 2021 (IT) 102021000010145

(51) Int. Cl. G21B 1/05; G21B 1/13; G21B 1/17

(52) U.S. Cl. CPC G21B 1/057; G21B 1/13; G21B 1/17

(57) ABSTRACT

A spherical-type tokamak, configured to operate with plasma in negative triangularity, includes a chamber for housing a plasma, and is configured so that, during operation, the plasma defines a profile having both in an upper region and in a lower region of said plasma, radially internal and external plasma separator legs. The chamber includes upper and lower regions for receiving the upper and lower plasma regions. The upper and/or lower regions of the chamber are equipped with at least one divertor. The at least one divertor includes a divertor plate and divertor field coils. The divertor field coils are configured to drive the radially inner and radially outer plasma separator legs towards the respective divertor plate. The at least one divertor includes an inlet which is located in an external support vessel in a radially outermost position with respect to a point of the respective region.

### FIELD OF THE ART

The present invention relates to a nuclear fusion reactor of the tokamak type, in particular of the spherical tokamak type configured to operate with plasma in negative triangularity.

### STATE OF THE ART

Fusion reactions are considered a great opportunity to generate abundant ecological and economically scalable energy for terrestrial use and for space missions. One of the known systems of nuclear fusion is the so-called spherical tokamak.

A low aspect ratio tokamak, or spherical, is a tokamak in which the ratio of the major radius (distance from the center of the toroidal body to the central axis) to the minor radius (radius of the toroidal body) is around one. Such low aspect ratios result in a very natural plasma conformation, with high elongation and triangularity, which has a number of beneficial effects on the plasma.

The advantages of this design were known for years before the first model was built [Peng (1986)], but it was believed then that the limitations relating to the width of the central column would make it difficult to obtain, with a toroidal field coil and a solenoid central, the toroidal field and the ohmic induction necessary for its functioning [Lazarus 1985)].

The first spherical tokamak built and put into operation was the START device [Sykes (1992)], which rapidly reached values of β, that is the ratio between plasma pressure and magnetic pressure necessary to confine the plasma, more than double [Gryaznevich (1998)] compared to the maximum value previously found on a conventional tokamak [Strait (1994)]. This meant that a smaller toroidal field was required to achieve high plasma pressures.

In the past, other advantages of this design have also been noted in addition to the increased stability limit β, including high levels of self-induced current within the plasma [Akers (2000)], high levels of energy confinement (also higher than those of conventional tokamaks [Valovič (2009)]), good magnetohydrodynamic stability and reduction of both the amplitude and the number of unstable energy modes induced by particles as β increases [Gryaznevich (2004)].

After START various other devices have been built with these design characteristics, including PEGASUS [Fonck (1996)], Globus-M [Gusev (1999)], NSTX [Ono (2000)], MAST [Sykes (2001)], ETE [Berni (2003)], and others.

During the tokamak discharges, it was observed that the vertical distension of the plasma and the creation of a “D” shape could allow to obtain a double effect: reduction of energy transport through the plasma, with consequent reduction of the heating necessary to reach a given temperature, and increase in pressure limits before the onset of magnetohydrodynamic instability, which is known to cause shutdown by disruption [Troyon (1984)].

Some investigations on the effect of plasma conformation on confinement have been conducted by [Moret (1997)] on Tokamak à Configuration Variable (TCV), a “conventional” tokamak with aspect ratio R/a˜3.5 (although it can vary widely with conformation) and a large number of independent magnetic field coils, useful for allowing such investigations on the plasma conformation.

In all the cases analyzed in the course of these investigations, the plasma was limited to graphite tiles applied to the central column and the heating of the plasma was obtained by ohmic means, i.e. by resistive heating generated by the induced plasma current.

These investigations included the “inverted D” or “negative triangularity” shape, and found that a slightly negative or no triangularity guarantees better confinement than a positive triangularity. These experiments were then extended by [Pochelon (1999)] to heating by means of an electron cyclotron, which is able to change the deposition of the heating on different regions of the plasma and thus allows to estimate the effect of conformation on the energy confinement through the plasma.

It has been observed that the negative triangularity has an advantageous effect on the energy confinement, calculated as (1+δ)−0.35, but that this tends to decrease as the thermal power increases. It was also found that plasma instabilities associated with heating, which can degrade confinement, are less pronounced when high heat output is applied in the case with negative triangularity.

Other tests were then conducted on TCV by [Camenen (2007)] which showed that, in order to obtain the same temperature profiles, in the case with negative triangularity (δ=−0.4) only half of the thermal power required by the case is required with positive triangularity (δ=0.4). From further tests performed by [Fontana (2007)] and [Huang (2018)] on TCV it was then found that the conformation of the plasma with negative triangularity reduces fluctuations in density and temperature as well as energy transport. Further investigations into the effects of triangularity, detailed in [Marinoni (2019), Austin (2019)] were then conducted on DIII-D, another tokamak with aspect ratios within the conventional range (R/a ˜4.25). As in the TCV, the discharges were limited on graphite tiles applied to the central column, but in these tests it was possible to apply much greater heating to the electrons and ions, so that the pressure was able to reach conditions of relevance for the purpose of use. of the reactor.

Previously it was observed that, by applying sufficient heating, in the positive triangularity form the plasma spontaneously enters a “high confinement mode” (mode H), in which the energy confinement increases considerably and a pressure pedestal is formed. at the edge of the plasma; however, this pedestal involves instabilities known as “Edge Localized Modes” (ELM), which degrade the confinement and can lead to reactor damage and termination of the shot by disruption.

In these investigations on the negative triangularity carried out on DIII-D it was found that it is possible to obtain a confinement similar to this H mode without however the ELM instabilities associated with this mode. Thanks to the heating systems available on DIII-D it was possible to investigate cases in which the temperature of the ions was equal to the temperature of the electrons, as well as cases with a much higher electrons temperature, and in all cases the turbulent fluctuations in the outer half of the plasma were reduced by 10-50% in the presence of negative triangularity compared to an equivalent discharge with positive triangularity.

Further discharges on TCV with equal temperatures for electrons and ions were then analyzed by [Merlo (2019)], also finding in this case a better confinement with negative triangularity.

These cases of negative triangularity have also been extensively analyzed with theoretical models.

An analytical model of high p equilibria (plasma pressure/magnetic pressure) was used by [Hsu (1996)] to study the effects on stability determined by geometry, finding that negative triangularity could have beneficial effects on tokamak stability.

An analysis of plasma modes interfaced with a numerical magnetohydrodynamic model was performed by [Rewoldt (1982)], and showed a similar pattern with low p values, although this was not considered particularly significant.

The first attempt to reproduce the experimental results of negative triangularity, with improvements in terms of confinement, was made by [Marinoni (2009)] using a local gyrokinetic code to simulate different plasma regions during TCV firing. On this occasion, a reduction of the electronic heat flux was found in the presence of negative triangularities, but only in the regions where the triangularity has a significant effect on the local geometry, which does not happen in the regions close to the plasma core, where it was experimentally observed. a suppression of turbulence.

Further local gyro-kinetic simulations of firing in TCV were performed by [Merlo (2015)], although they failed to reproduce the radially uniform improvement in confinement observed experimentally.

It is also known the possibility, in order to ignite the plasma current inside a tokamak, to use the method called “Dual Null Merging” (DNM), which involves generating a pair of annular plasmas in the upper and lower region of the tokamak, and subsequently to combine them in order to obtain a single plasma [Yamada (2013)].

### REFERENCES

Akers, R J, Bond, A., Buttery, R J, Carolan, P G, Counsell, G F, Cunningham, G., Fielding, S J, Gimblett, C G, Gryaznevich, M., Hastie, R J and Helander, P., 2000. Steady state operation of spherical tokamaks. Nuclear Fusion, 40 (6), p. 1223.
Austin, M E, Marinoni, A., Walker, M L, Brookman, M W, DeGrassie, J S, Hyatt, A W, McKee, G R, Petty, C C, Rhodes, T L, Smith, S P and Sung, C., 2019. Achievement of reactor-relevant performance innegative triangularity shape in the DIII-D tokamak.

Physical review letters, 122 (11), p. 115001.
Berni, L A, Del Bosco, E., Ferreira, J G, Ludwig, G O, Oliveira, R M, Shibata, C S, Barbosa, LFFPW and Vilela, W A, 2003. Overview and initial results of the ETE spherical tokamak.
Camenen, Y., Pochelon, A., Behn, R., Bottino, A., Bortolon, A., Coda, S., Karpushov, A., Sauter, O. and Zhuang, G., 2007. Impact of plasma triangularity and collisionality on electron heat transport in TCV Lmode plasmas. Nuclear fusion, 47 (7), p. 510.
Fonck, R., Garstka, G., Intrator, T., Lewicki, B., Thorson, T., Toonen, R., Tritz, K L, White, B. and Winz, G., 1996, November. Overview of the Pegasus Extremely Low-Aspect Ratio Tokamak. In APS Division of Plasma Physics Meeting Abstracts (pp. 2R-06).
Fontana, M., Porte, L., Coda, S., Sauter, O. and TCV Team, 2017. The effect of triangularity on fluctuations in a tokamak plasma. Nuclear Fusion, 58 (2), p. 024002.
Gusev, V K, Golant, V E, Gusakov, E Z, D'yachenko, V V, Irzak, M A, Minaev, V B, Mukhin, E E, Novokhatskii, A N, Podushnikova, K A, Razdobarin, G T and Sakharov, N V, 1999. Globus-M spherical tokamak. Technical Physics, 44 (9), pp. 1054-1057.
Gryaznevich, M., Akers, R., Carolan, P G, Conway, N J, Gates, D., Field, A R, Hender, T C, Jenkins, I., Martin, R., Nightingale, M P S and Ribeiro, C., 1998. Achievement of record β in the START spherical tokamak. Physical review letters, 80 (18), p. 3972.
Gryaznevich, M P and Sharapov, S E, 2004. Beta-dependence of energetic particle-driven instabilities in spherical tokamaks. Plasma physics and controlled fusion, 46 (7), p. S15.
Hender, T C, Allfrey, S J, Akers, R., Appel, L C, Bevir, M K, Buttery, R J, Gryaznevich, M., Jenkins, I., Kwon, O J, McClements, K G and Martin, R., 1999. Magneto-hydro-dynamic limits in spherical tokamaks. Physics of Plasmas, 6 (5), pp. 1958-1968.
Hsu, S C, Artun, M. and Cowley, S C, 1996. Calculation and interpretation of analytic high-beta poloidal equilibria in finite aspect ratio tokamaks. Physics of Plasmas, 3 (1), pp. 266-274.
Huang, Z. and Coda, S., 2018. Dependence of density fluctuations on shape and collisionality in positive-and negative triangularity tokamak plasmas. Plasma Physics and Controlled Fusion, 61 (1), p. 014021.
Lazarus, E A, Attenberger, S E and Baylor, L R, 1985. Feasibility study for the spherical torus experiment (No. ORNL/T M—9786). Oak Ridge National Lab.
Marinoni, A., Brunner, S., Camenen, Y., Coda, S., Graves, J P, Lapillonne, X., Pochelon, A., Sauter, O. and Villard, L., 2009. The effect of plasma triangularity on turbulent transport: modeling TCV experiments by linear and non-linear gyrokinetic simulations. Plasma Physics and Controlled Fusion, 51 (5), p. 055016.
Marinoni, A., Austin, M E, Hyatt, A W, Walker, M L, Candy, J., Chrystal, C., Lasnier, C J, McKee, G R, Odstrcil, T., Petty, C C and Porkolab, M., 2019 H-mode grade confinement in L-mode edge plasmas at negative triangularity on DIII-D. Physics of Plasmas, 26 (4), p. 042515.
Merlo, G., Brunner, S., Sauter, O., Camenen, Y., Gorler, T., Jenko, F., Marinoni, A., Told, D. and Villard, L., 2015. Investigating profile stiffness and critical gradients in shaped TCV discharges using local gyrokinetic simulations of turbulent transport. Plasma Physics and Controlled Fusion, 57 (5), p. 054010.
Merlo, G., Fontana, M., Coda, S., Hatch, D., Janhunen, S., Porte, L. and Jenko, F., 2019. Turbulent transport in TCV plasmas with positive and negative triangularity. Physics of Plasmas, 26 (10), p. 102302.
Moret, J M, Franke, S., Weisen, H., Anton, M., Behn, R., Duval, B P, Hofmann, F., Joye, B., Martin, Y., Nieswand, C. and Pietrzyk, Z A, 1997. Influence of plasma shape on transport in the TCV tokamak. Physical review letters, 79 (11), p. 2057.
Ono, M., Kaye, S M, Peng, Y K, Barnes, G., Blanchard, W., Carter, M D, Chrzanowski, J., Dudek, L., Ewig, R., Gates, D. and Hatcher, R E, 2000. Exploration of spherical torus physics in the NSTX device. Nuclear Fusion, 40 (3Y), p. 557.
Peng, Y M and Strickler, D J, 1986. Features of spherical torus plasmas. Nuclear Fusion, 26 (6), p. 769.
Pochelon, A., Goodman, T P, Henderson, M., Angioni, C., Behn, R., Coda, S., Hofmann, F., Hogge, J P, Kirneva, N., Martynov, A A and Moret, J M, 1999. Energy confinement and MHD activity in shaped TCV plasmas with localized electron cyclotron heating. Nuclear Fusion, 39 (11Y), p. 1807.
Rewoldt, G., Tang, W M and Chance, M S, 1982. Electromagnetic kinetic toroidal eigenmodes or general magnetohydrodynamic equilibria. The Physics of Fluids, 25 (3), pp. 480-490.
Strait, E J, 1994. Stability of high beta tokamak plasmas. Physics of Plasmas, 1 (5), pp. 1415-1431.
Sykes, A., Del Bosco, E., Colchin, R J, Cunningham, G., Duck, R., Edlington, T., Goodall, DHJ, Gryaznevich, M P, Holt, J., Hugill, J. and Li, J., 1992. First results from the START experiment. Nuclear fusion, 32 (4), p. 694.
Sykes, A., Ahn, J W, Akers, R., Arends, E., Carolan, P G, Counsell, G F, Fielding, S J, Gryaznevich, M., Martin, R., Price, M. and Roach, C., 2001. First physics results from the mast mega-amp spherical tokamak. Physics of Plasmas, 8 (5), pp. 2101-2106.
Troyon, F., Gruber, R., Saurenmann, H., Semenzato, S. and Succi, S., 1984. MHD-limits to plasma confinement. Plasma physics and controlled fusion, 26 (1A), p. 209.
Valovič, M., Akers, R., Cunningham, G., Garzotti, L., Lloyd, B., Muir, D., Patel, A., Taylor, D., Turnyanskiy, M. and Walsh, M., 2009. Scaling of H-mode energy confinement with Ip and B T in the MAST spherical tokamak. Nuclear Fusion, 49 (7), p. 075016.
Yamada, T, Imazawa, R, Kamio, S, Hihara, R, Abe, K, Sakumura, M, Cao, Q H, Takase, Y, Ono, Y, Sakakita, H, Koguchi, H, Kiyama, S, and Hirano, Y. Double Null Merging Start-up Experiments in the University of Tokyo Spherical Tokamak. IAEA: N. p., 2010. Web.

The Applicant observes that no attempts have so far been made to implement a spherical tokamak with negative triangularity, in part due to the construction complexity and software integrations necessary to manage a fusion plasma with triangularity negative inside a spherical tokamak. No attempts were made even in the deflected configuration, partly due to problems with the vertical stability of the plasma.

US2010/063344 relates to a tokamak reactor configured to operate with plasma in positive triangularity. The solution described in “Coils and power supply design for the SMall Aspect Ratio Tokamak (SMART) of the University of Seville” by Manuel Agredano Torres focuses on the design of Tokamak coils and power supply with low aspect ratio (low-aspect ratio).

### OBJECTIVES OF THE INVENTION

The object of the present invention is to propose a spherical tokamak-type reactor configured to operate with plasma in negative triangularity capable of overcoming, at least in part, the drawbacks of traditional solutions.

Another object of the invention is to propose a tokamak reactor which can operate at high temperatures.

Another object of the invention is to propose a tokamak reactor which can operate with reduced turbulence.

Another object of the invention is to propose a tokamak reactor which allows to confine the plasma with reduced magnetic fields.

Another object of the invention is to propose a tokamak reactor which is particularly compact.

Another object of the invention is to propose a tokamak reactor which requires reduced installation spaces.

Another object of the invention is to propose a tokamak reactor which can be produced with low costs.

Another object of the invention is to propose a tokamak reactor which is efficient both in start-up and steady state conditions.

Another purpose of the invention is to propose a tokamak reactor that can be ignited by means of plasma-startup schemes that do not use a solenoid (non-inductive), such as through the Double Null Merging (DNM) method, or other non-inductive startup schemes such as Local Helicity Injection.

Another object of the invention is to propose a tokamak reactor which has an alternative and/or improved characterization, both in constructive and functional terms, with respect to the traditional ones.

Another object of the invention is to propose a tokamak reactor which is commercial.

### SUMMARY OF THE INVENTION

All these purposes, either alone or in any combination thereof, and others which will result from the following description, are achieved, according to the invention, with a spherical type tokamak reactor (hereinafter also only “tokamak”) configured to operate with negative triangularity according to the attached claims.

Preferably, the spherical tokamak comprises a chamber.

Preferably, a plasma is confined to said chamber.

Preferably, said plasma has a profile having, in an upper region of said plasma, a radially internal plasma separatrix leg.

Preferably, said plasma has a profile having, in an upper region of said plasma, a radially external plasma separator leg.

Preferably, said plasma has a profile having, in a lower region of said plasma, a radially internal plasma separator leg.

Preferably, said plasma has a profile having, in a lower region of said plasma, a radially external plasma separator leg.

Preferably, said chamber has an upper region.

Preferably, said chamber has a lower region.

Preferably, the upper region of the plasma extends into the upper region of the chamber.

Preferably, the lower region of the plasma extends into the lower region of the chamber.

Preferably, the upper region of the chamber is closed at the top by a respective divertor plate.

Preferably, the lower region of the chamber is closed at the bottom by a respective divertor plate.

Preferably, the upper region of the chamber is provided with a respective divertor for negative triangularity divertor.

Preferably, the lower region of the chamber is provided with a respective divertor for negative triangularity divertor.

Preferably, each divertor for negative triangularity comprises a respective of said divertor plates.

Preferably, each divertor for negative triangularity comprises multiple divertor field coils.

Preferably, the divertor field coils guide the radially inner plasma separator leg towards the respective divertor plate.

Preferably, the divertor field coils guide the radially outer plasma separator leg towards the respective divertor plate.

Preferably, the divertor for negative triangularity has a further external entrance into the vessel with respect to the X point of the plasma.

Preferably, the negative triangularity divertor guides the radially outer plasma separator leg so that the latter does not intersect with the vessel.

Preferably, the negative triangularity divertor guides the radially outer plasma separator leg so that the latter does not intersect with the divertor plates.

Preferably, the negative triangularity divertor guides the radially outer plasma separator leg so that the latter does not intersect with any of the divertor field coils.

Preferably, the spherical tokamak comprises poloidal field coil magnets.

Preferably, said poloidal field coil magnets are configured to support fusion plasma with both positive and negative triangularity.

Preferably, said divertor field coils cooperate with said poloidal field coil magnets to support a negative triangularity fusion plasma.

Preferably, each of said divertor plates comprises a base plate.

Preferably, said base plate has a circular profile.

Preferably, each of said divertor plates comprises a first heat-absorbing annular projection.

Preferably, said first annular thermo-absorbing projection extends from said base plate, inside said chamber.

Preferably, said first heat-absorbing annular projection is arranged along a first circumference having a first diameter.

Preferably, each of said divertor plates comprises a second heat-absorbing annular projection.

Preferably, said second thermo-absorbing annular projection extends from said base plate, inside said chamber.

Preferably, said first heat-absorbing annular projection is arranged along a second circumference.

Preferably, said second circumference is concentric with the first circumference.

Preferably, said second circumference has a second diameter greater than said first diameter.

Preferably, said spherical tokamak comprises a control device.

Preferably, said control device is provided with an Artificial Intelligence agent, IA.

Preferably, said control device is configured to manage the nuclear fusion process.

Preferably, said spherical tokamak comprises a robotic mechanical structure.

Preferably, said robotic mechanical structure is configured to vertically move one or more of said poloidal field coil magnets.

Preferably, said control device is configured to control said robotic mechanical structure.

Preferably, said robotic mechanical structure is active on one or more internal poloidal field coils forming part of said poloidal field coil magnets.

Preferably, said robotic mechanical structure is active on at least one lower and one upper internal field poloidal coil, having a larger diameter than the other internal field poloidal coils.

### DESCRIPTION OF THE FIGURES

Further characteristics and advantages will become clearer from the following description of some embodiments of the present invention. This description refers to the attached drawings, provided only by way of non-limiting example, in which:

FIG. 1 shows a block diagram of a spherical tokamak according to the present invention;

FIG. 2 schematically shows some details of the spherical tokamak of FIG. 1;

FIG. 3 schematically shows some details of the spherical tokamak of FIG. 1 in normal operation condition

FIG. 4 schematically shows a part of a structural component of the spherical tokamak of FIGS. 1-2;

FIG. 5 shows a cross-sectional view (plane YY of FIG. 4) of the component of FIG. 4, and

FIGS. 6A-E show the startup phases that bring the tokamak, and the plasma contained therein, to the condition of normal fusion burn operation shown in FIG. 3.

### DETAILED DESCRIPTION OF THE INVENTION AND OF SOME OF ITS PREFERRED EMBODIMENTS

With reference to accompanying drawings, the reference number 1 indicates the spherical tokamak type reactor according to the present invention.

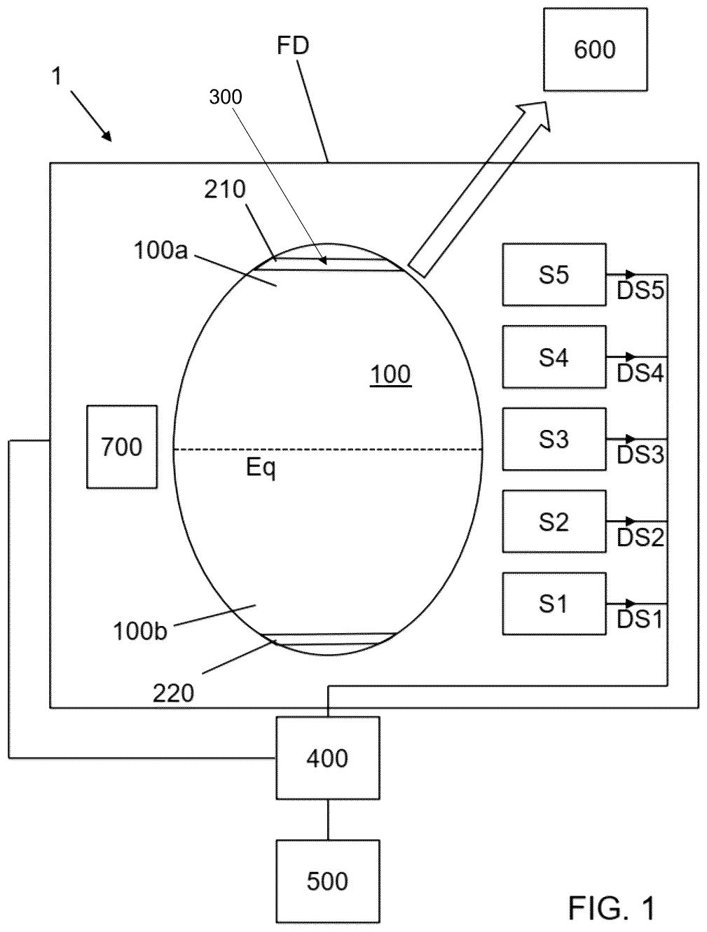

The spherical tokamak reactor 1 (FIG. 1)—hereinafter also only “tokamak”—comprises a chamber 100 for housing a plasma, that is, in which a plasma is confined. For example, a hydrogen plasma or a plasma obtained from hydrogen isotopes (e.g. deuterium, tritium, etc.) can be used. A plasma obtained from other elements (e.g. helium) or isotopes of the same can also be used.

Advantageously, the chamber 100 is a vacuum chamber. A vacuum pump (not shown) is provided to create and maintain a suitable pressure in chamber 100.

The Spherical Tokamak 1 has a low aspect ratio and, in particular, less than 2 and, preferably with 1.4<A<1.9

A Spherical Tokamak 1, or low-aspect ratio tokamak, is described here (preferably in which 1.4<A<1.9), capable of supporting a fusion plasma configured in negative triangularity (−0.9<δ<0) with high elongation (2<κ<2.9), a high plasma current (Ip>1 MA), a high toroidal field (B_{T}>2.0T), a high normalized beta (1.5<β_{N}<3) during operation and with a greater radius R>0.8 m and a radius smaller than >0.4 m.

Conveniently, the tokamak according to the invention can be configured to operate with a magnetic field higher than 3T, and preferably lower than 20T.

Therefore, the tokamak according to the invention is suitably configured—i.e. the configuration (in terms of shape and size) of the chamber 10 for the plasma and the magnets that generate the magnetic field that allows ignition and/or maintenance and/or heating and/or compression of the plasma present inside the chamber 10 are positioned and/or sized—to function/operate with plasma in a condition of negative triangularity. In particular, by “negative triangularity” we mean that the cross section of the plasma has a backward D shape in which the curved part of the D faces inwards, i.e. towards the center.

More in detail, plasma triangularity is defined as the value where “R_{geo}” indicates the value of the radial coordinate of the center of the plasma, (calculated as “Rₘₐₓ+Rₘᵢₙ/2”), “R” is the radial coordinate of the point extreme of the separators along the z-axis, and “a” is the length of the smallest radius of the plasma. Substantially therefore, in conditions of negative triangularity, the plasma has the largest surface towards the inside of cavity 1. Advantageously, in this way it is possible to reduce the operating and construction costs of the tokamak itself, since magnets of lesser power are required.

The chamber 100 can have a substantially spherical shape; for example, the chamber 100 can be an oblate spheroid, preferably having a longer vertical diameter than the horizontal diameters. The chamber 100 can however also have other forms, e.g. a toroidal shape.

Conveniently, the chamber 100 can have a plane of symmetry, preferably horizontal, called the equatorial plane, or EQ.

Conveniently, the chamber 100 may have a shape configured to accommodate a plasma in a negative triangularity configuration. In particular, the mechanical and/or electronic components (excluding the magnets and the corresponding components) positioned inside the chamber itself can preferably be positioned internally with respect to the PXP. The chamber 100 has an upper region 100a and a lower region 100b.

Advantageously, the chamber 100 can comprise at least one arm, and preferably a pair of arms 101, 102 configured to accommodate the external separating legs L2 of the plasma. Advantageously, a first arm 101 can be positioned at the upper region 100a, and more preferably at the upper outer corner of the chamber 100. Advantageously, a second arm 102 can be positioned at the lower region 100b, and more preferably at the of the lower external corner of the chamber 100.

The upper region 100a and the lower region 100b can both be closed, respectively above and below, by a respective divertor plate 210, 220.

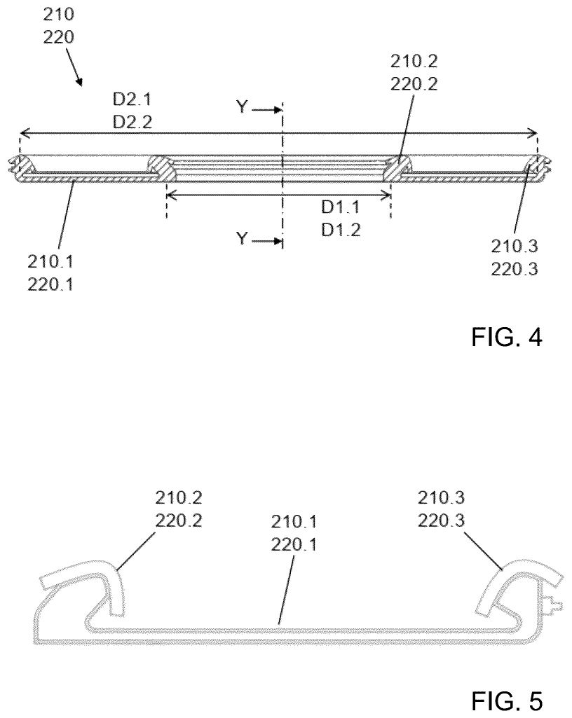

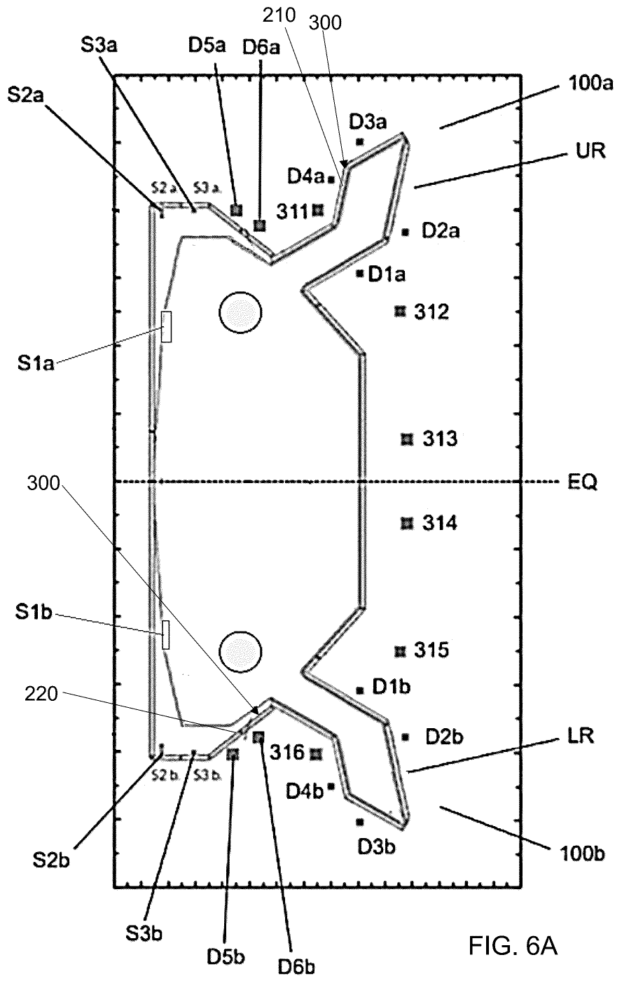

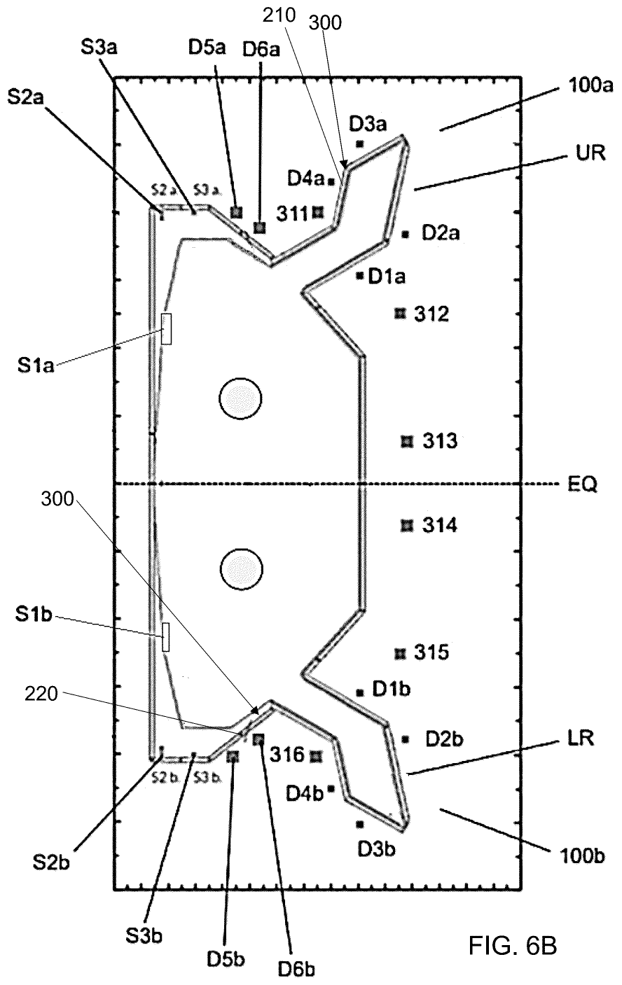

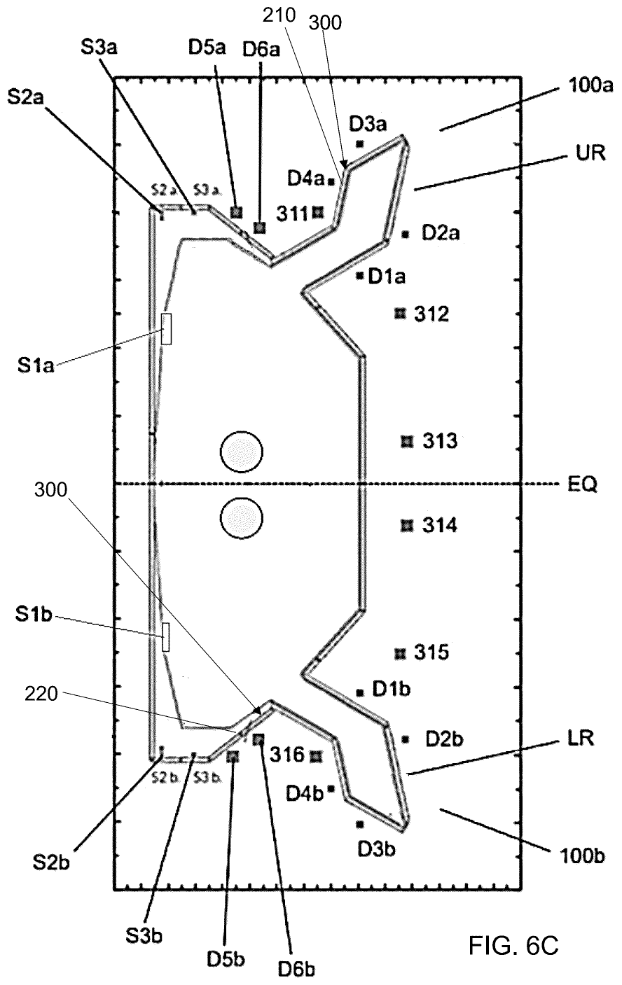

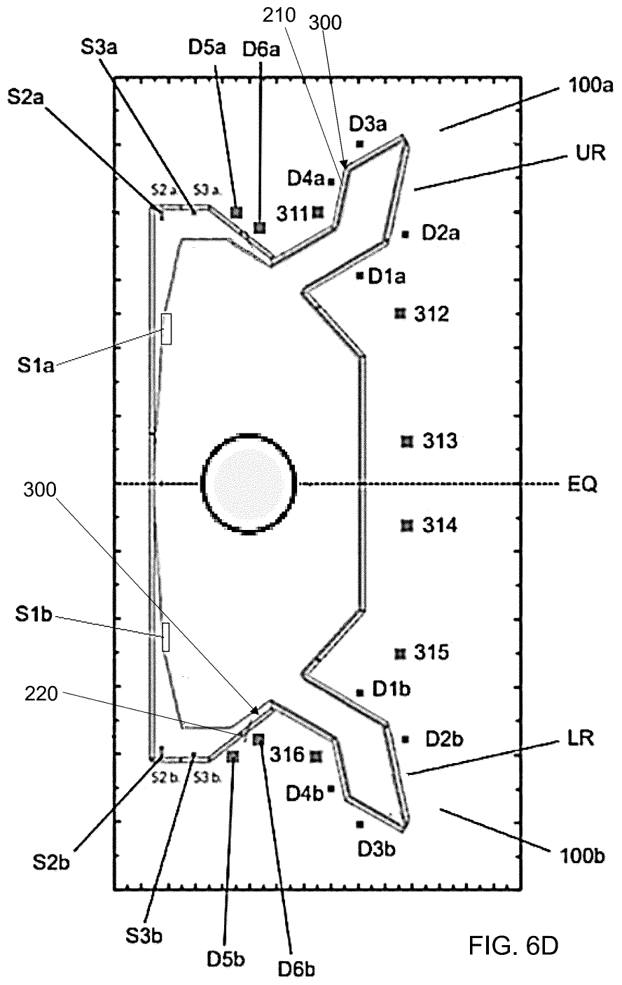

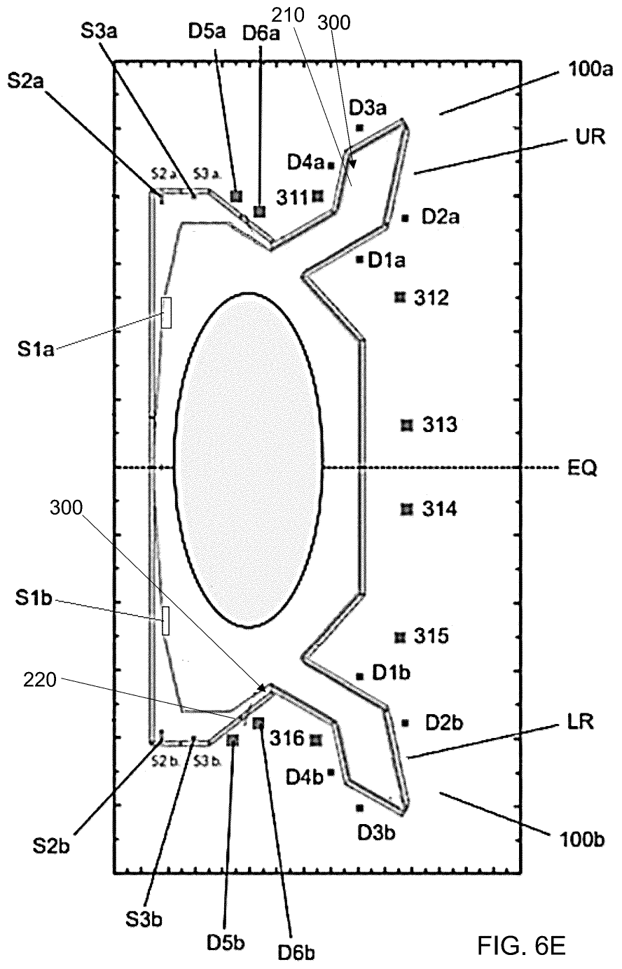

Each of the divertor plates 210, 220 (FIGS. 4-5) comprises a base plate 210.1, 220.1 having a substantially annular profile.

Each base plate 210.1, 220.1 has a central circular through hole for coupling with the central column 110 (which will be described below).

Each divertor plate 201, 220 comprises a first heat-absorbing annular projection 210.2, 220.2.

Each first annular thermo-absorbing projection 210.2, 220.2 extends from the respective base plate 210.1, 220.1 inside the chamber 100.

Each first annular thermo-absorbing projection 210.2, 220.2 is arranged along a first circumference having a first diameter D1.1, D1.2.

Each divertor plate 201, 220 comprises a second heat-absorbing annular projection 210.3, 220.3.

Each second thermo-absorbing annular projection 210.3, 220.3 extends from the respective base plate 210.1, 220.1 inside the chamber 100.

Each second thermo-absorbing annular projection 210.3, 220.3 is arranged along a second circumference, concentric with respect to the first circumference.

The second circumference has a second diameter D2.1, D2.2 which is greater than said first diameter D1.1, D1.2.

Preferably, the first thermo-absorbing annular projection 210.2, 220.2 has a curved profile, with the convexity facing the internal part of the chamber 100 and the concavity facing the base plate 210.1, 220.2.

Preferably, the second thermo-absorbing annular projection 210.3, 220.3 has a curved profile, with the convexity facing the internal part of the chamber 100 and the concavity facing the base plate 210.1, 220.2.

Preferably, the first heat-absorbing annular projection 210.2, 220.2 comprises or consists of a plurality of heat-absorbing tiles made, for example, of graphite.

Preferably, the second heat-absorbing annular projection 210.3, 220.3 comprises or consists of a plurality of heat-absorbing tiles made, for example, of graphite.

Each divertor plate 210, 220 is capable of supporting shots with negative triangularity and with positive triangularity inside the spherical tokamak 1; in particular, the transition from positive triangularity to neutral triangularity and negative triangularity is supported.

In general terms, the Applicant observes that a divertor is a useful structure for the disposal of heat and particles in tokamaks in which the scrape-off layer (i.e. the outermost flow surface of the plasma) is directed towards heat-resistant plates by means of ions pumps to remove exhausted particles. The divertor plates 210, 220 are shaped in such a way as to allow the separator to contact and deposit most of the residual heat from the main plasma volume in both negative triangularity and positive triangularity configurations. For the configuration with negative triangularity, the second thermo-absorbing annular projection 210.3, 220.3 is used, so as to cope with the particular position of the point X and of the associated separator legs. For the configuration with positive triangularity, the first thermo-absorbing annular projection 210.2, 220.2 is used, so as to cope with the particular position of the point X and of the associated separator legs. Each of the divertor plates 210, 220 is part of a respective divertor configured to operate with plasma in negative triangularity 300 (hereinafter also referred to as “divertor for negative triangularity”), which will be described below.

Conveniently, the divertor configured to operate with plasma in negative triangularity 300 can be provided only on one of the two regions 100a or 100b of the chamber 100, or a corresponding/respective divertor 300 can be provided in each of the two regions 100a or 100b.

Inside the chamber 100 there may be a conductive central column 110.

Conveniently, in a possible embodiment, during the start-up/start-up phase the reactor 1 is configured not to use any solenoid and, in particular, to operate according to plasma-startup schemes not using a solenoid (of the “non-inductive” type).

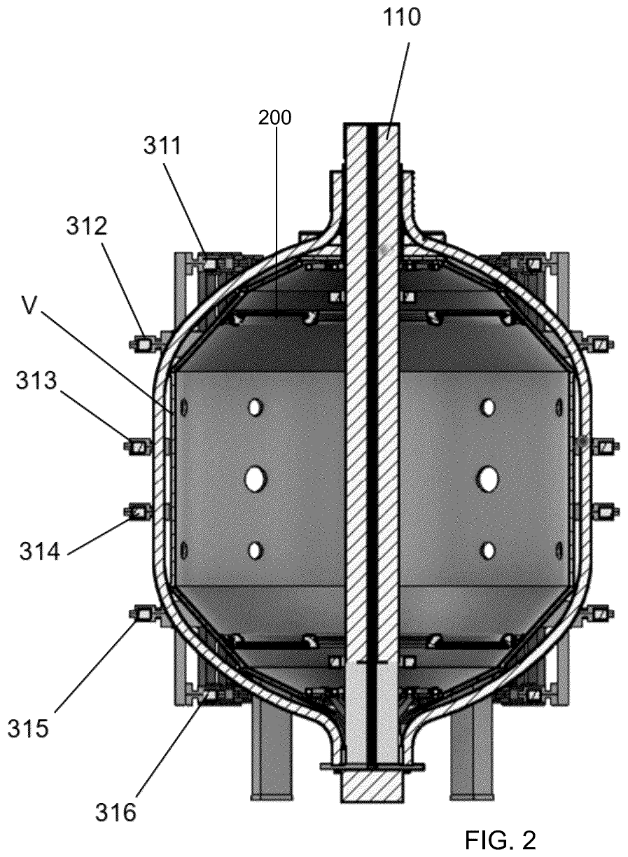

Preferably, a plurality of poloidal magnets (or poloidal field coils) 311-316 is also present. For example, the magnets 311-316 can be arranged outside the chamber 100 (as schematically shown in FIG. 2). However, it is envisaged that the poloidal magnets 311-316 can also be arranged inside the chamber 100.

The magnets 311-316 extend around the column 110.

For example, six poloidal magnets 311-316 can be arranged around the central column 110 (FIG. 2). However, the use of a different number of annular/poloidal magnets is also envisaged.

Preferably, as shown schematically in FIG. 2, the poloidal magnets 311 and 316 have a smaller radius than the poloidal magnets 312-315.

The poloidal magnets 312-315 preferably have the same radius.

From a practical point of view, the chamber 100 is the internal space of the spherical tokamak 1.

In a per se known way, a gas is fed and ionized to form said plasma.

Preferably, the spherical tokamak 1 further comprises one or more detection devices S1-S5 associated with the chamber 100.

For example, the detection devices comprise one or more of: a temperature sensor S1; an S2 radiation meter; a fusion event detector S3; an S4 galvanometer; a magnetometer or magnetic field meter S5.

Preferably, the temperature sensor S1 does not directly measure the temperature inside the chamber 100. The temperature sensor S1 is preferably a device configured to indirectly derive the temperature present in the chamber 100, possibly at specific points inside the chamber 100, based on other directly detected parameters (e.g. magnetic field detection and scintillation counting).

Preferably, the radiation meter S2 is capable of detecting one or more radiation bands, e.g. visible radiation, IR radiation, gamma radiation, etc. The S2 radiation meter can be embodied as a single device or can include several detectors, e.g. each dedicated to a specific radiation band.

The fusion event detector S3 can be, for example, a neutron detector, e.g. a scintillation counter.

Each of the S1-S5 detection devices is configured to generate respective DS1-DS5 detection signals.

Based on the DS1-DS5 sensing signals provided by the S1-S5 sensing devices, a controller 400 can be configured to control the nuclear fusion process.

The spherical tokamak 1 is part of or forms a fusion device FD, which can include, in a per se known manner, a heating and current profile control system composed of gyrotrons, tetrodes, neutral beam injectors and/or other schemes for the purpose of heating both ions and electrons and supplying current to the main plasma MPV volume.

To manage the fusion process, as already mentioned, the system 1 comprises a control device 400.

The control device 400 is coupled to the detection devices S1-S5 so as to receive detection signals DS1-DS5, and to the fusion device FD in order to check its operation.

In one embodiment, the control device 400 is coupled to a memory 500 which contains control/reference parameters useful for managing the nuclear fusion process.

The control device 400 can comprise a computer (or a set of computers operating according to a given logic/hardware structure), suitably programmed to perform the operations disclosed and claimed herein.

In particular, a reconnection and compression process controlled by the control device 400 can be performed to bring the fusion plasma to conditions of net energy gain and thus release energy.

In addition to the above, the spherical tokamak 1 may further comprise toroidal magnets (not shown). While the central axis of the poloidal magnets 311-316 is vertical, coinciding with the conductive central column 110, the central axis of the toroidal magnets is defined by a circumference extending horizontally around the chamber 100.

Basically the combination of the toroidal and of the poloidal ones 311-316 and, if present, of the central solenoid 110, it can be configured to generate a region where the magnetic field is more intense (High Field Side, HFS), positioned towards the inside of the chamber 100, and a region where the magnetic field is less intense positioned towards the outside of the chamber (Low Field Side, LFS). Advantageously, the tokamak according to the invention is configured to form a plasma which, under normal operating conditions, has a larger surface in correspondence with the region where the magnetic field is most intense (HFS).

Advantageously, the control device 400 is configured to control the magnetic field generated by the toroidal magnets, preferably by regulating a current flowing through them.

Advantageously, the spherical tokamak 1 comprises an output stage 600, preferably comprising a neutron and gamma radiation capture apparatus, configured to receive energy from the heated plasma and produce thermal and/or electrical energy at the output. By means of the output stage 600, the energy generated by the fusion process can be exploited in practical scenarios, such as industrial plants, power plants, space propulsion applications, etc.

For example, the operation of the output stage 600 can be based on molten lithium, which is hit by the neutrons generated by fusion events inside the chamber 100 and thus exchanges heat with an external structure.

The spherical tokamak with negative triangularity 1 comprises a vessel V, in particular an external support vessel, which constitutes the structural body of the system and supports structures such as neutron mantle, poloidal field coils (which will be described further below), coils of toroidal field, divertor coils, control coils, conformation coils, diagnostic ports, heating and current control ports, power ports, cooling systems, and any other subsystem/component necessary for normal fusion burn operations.

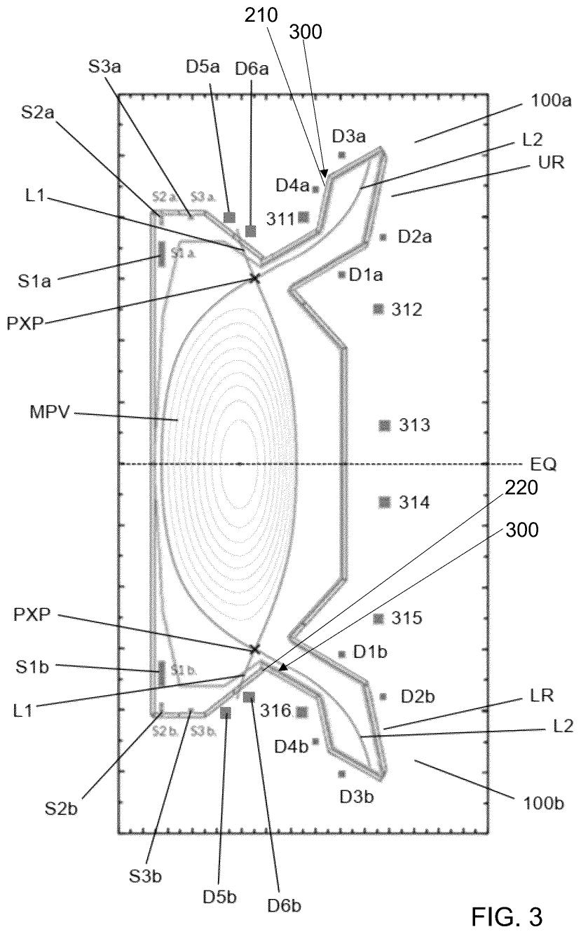

As shown schematically in FIG. 3, the confined plasma has an upper region UR and a lower region LR.

More specifically, the upper plasma region UR extends into the upper region 100a of the chamber 100, and the lower plasma region LR extends into the lower region 100b of the chamber 100.

In the upper region UR and in the lower region LR, the profile of the plasma has a radially internal plasma separator leg L1 and a radially external plasma separator leg L2. In this context, the expressions “radially internal” and “radially external” mean respectively “proximal” and “distal” to the central column 110. The radially internal plasma separator leg L1 and the radially external plasma separator leg L2 can be generically referred to as “separator legs”.

It is clear from FIG. 3 that the convex portion of the MPV is the internal one. Substantially, therefore, the plasma is arranged in a condition of negative triangularity.

Preferably, the upper region 100a and the lower region 100b are both provided with a respective divertor for negative triangularity 300 (as shown in FIG. 3).

Preferably, the negative triangularity diverter 300 can be a super-X negative triangularity divertor.

Advantageously, the portion of the divertor 300 within which the extension of the radially external plasma separator leg L2 is inserted comprises an inlet port which is positioned radially further outward with respect to the point PXP where the two legs L1 and L2 cross.

The negative triangularity divertor 300 comprises various conformation coils, also referred to as divertor field coils. The conformation coils guide each of the radially outer plasma separator legs L2 towards the respective divertor plate 210, 220.

The divertor for negative triangularity 300 has an inlet located in the vessel V in an outermost position (i.e. at a greater distance from the central column 110) with respect to the X point of the PXP plasma. In contrast, known spherical tokamaks have the divertor entrance positioned further inland than the X point of the plasma and in the center of the main plasma.

Conveniently, the inlet comprises or consists of that portion of divertor 300 from which the exhausted and/or neutral gases which no longer make up the plasma are sucked.

Conveniently, the PXP can be located further out from the center of the plasma.

In particular, the negative triangularity divertor 300 guides the radially internal plasma separator legs L1, L2 such that they do not intersect the vessel V, the divertor plates 210, 220 or any of the divertor field coils. The divertor field coils are indicated in FIG. 3 with the references D1a-D6a, D1b-D6b.

Advantageously, the negative triangularity divertor 300 is capable of absorbing ignition level heat loads from deuterium-tritium plasma in negative triangularity. The negative triangularity divertor 300 increases the length of the deflected plasma path so that it can settle on a larger surface when it reaches divertor plates 210, 220, thanks to the consequent expansion of the flow. The divertors according to the prior art were designed for positive triangularity, so that in the present invention the entry of the divertor would begin at an even more external position in the vessel V and may require directing the plasma along a curved path to prevent it from intersecting the vessel V, the divertor plates or some of the divertor field reels. The divertor for negative triangularity 300 comprises a series of conformation coils, an extended heat-resistant cavity shaped in such a way as to allow the divertor to be placed in correspondence with the maximum greater radius, as well as the usual apparatuses associated with a divertor (heat-resistant deposition plates, pumps of ions, fuel exhaust systems and divertor cooling systems). It can also be connected to the heat extraction system for the mantle module, in order to increase the divertor's ability to handle heat and improve the overall energy efficiency of the spherical tokamak 1.

FIG. 3 schematically shows the poloidal field coils (311-316) extending all around the reactor. Poloidal field coils serve to shape the volume and surface of the plasma. The poloidal field coils 312, 313, 314, 315 are essentially adapted to form the main plasma volume MPV so as to bring it closer to the center of the reactor vessel. Going towards the ends (upper end and lower end) of the reactor, the poloidal field coils (e.g. 311, 316) perform the function of forming the volume and surface of the plasma near the end of the overall plasma volume. In the vicinity of the divertor point X is shown, where the plasma surfaces cross and continue in the form of separator legs (the plasma surface that continues towards the divertor), which strike the divertor plates 210, 220. At this point, the poloidal field coils play the role of forming that part of volume and plasma surface in such a way that the plasma surface (which at this point is only a separator leg) follows the desired path and settles on the divertor, which in this case is specially prepared for the spherical tokamak system with negative triangularity. The particular arrangement of the coils is therefore such as to guide the volume and the surface of the plasma so as to strike the divertor by negative triangularity at the appropriate points. In most cases, therefore, the position of the coils close to the equator can be changed without altering the equilibrium, but the position of this point X in both cases of positive and negative triangularity will be partially determined by the position of the coil closest at that point, so that the position of these coils will be partially determined by the desired triangularity. Furthermore, to carry out the start-up scheme for double null point merging, it is necessary that inside the vessel two null points are identified between two coils. It will then be necessary to position two pairs of coils, having a high current capacity, so that the respective zero point falls inside the container.

FIG. 3 also shows a series of divertor poloidal field coils (D1a-D6a, D1b-D6b), which help guide the plasma separator legs L1, L2 from point X to divertor plates 210, 220.

In in particular, the coils D5a-D6a, D5b-D6b drive the internal plasma separator legs L1 and the coils D1a-D4a, D1b-D4b drive the external plasma separator legs L2.

References S1a-S3a, S1b-S3b indicate the coils adjacent to the solenoid. The coils S1a-S3a, S1b-S3b can be moved vertically in order to optimize the configuration of the coils for starting the plasma and to minimize the neutron load on said coils during normal fusion burn.

Preferably, the magnets of the poloidal field coils included in the spherical tokamak 1 are configured to support both positive triangularity and negative triangularity.

In one embodiment, the magnets of the poloidal field coils comprise a first pair of coils 312, 313 above an equator Eq of said chamber 100 and a second pair of coils 314, 315 under said equator Eq. The first and second pair of coils are both configured to form a respective magnetic flux tube between the two coils forming the pair, wherein the magnetic flux tubes are combined and reconnected.

Preferably, the tokamak according to the invention has no central solenoid.

Advantageously, the magnets of the poloidal field coils allow to realize a starting scheme for merging with double null point. The Applicant observes that the spherical tokamak 1 requires a greater freedom of conformation than that provided by most tokamaks, this means that the coils will have to have a greater number of degrees of freedom than usual configurations. The magnets of the poloidal coils are configured in such a way that they can effectively support the double null point merging start pattern by forming magnetic flux tubes between two pairs of coils above and below the equator and thereby allowing those tubes to flow to combine and reconnect. For example, the two pairs of coils are provided with sufficient current carrying capacity to form such flow tubes, thus maximizing the plasma current, and are positioned in such a way as to allow the point magnetic null between them to be identified inside the vessel of.

In one embodiment, an artificial intelligence control system, AI (or agent AI), is used to carry out the evolution of the fusion campaign, and to operate the tokamak 1 reactor.

In particular, one or more parts of the tokamak reactor 1, such as for example the internal poloidal field coils, can be moved so as to provide an optimal configuration in all stages of the fusion campaign.

For example, one or more of the internal poloidal field coils S1aS3a, S1b-S3b, and in particular the internal poloidal field coils S3a, S3b, can be moved vertically to provide an optimal positioning for the coils for the various stages of the merger campaign, such as: 1. Startup; 2. Heating and current ramp up; 3. Normal fusion burn operation; 4. Ramp down and reactor shutdown. This entails advantages for the tokamak 1 reactor, and in particular the internal poloidal field coils will be subjected to different requirements and specific structural stresses in different stages of the fusion campaign. For example, in the Start-up stage, it will be optimal to have the internal poloidal field coils positioned so as to facilitate the start-up of Double Null Merging using the least possible amount of energy. Similarly, in the Normal fusion burn stage, it will be optimal to have the internal poloidal field coils isolated from direct line of sight from the main volume of the fusion plasma, as this will emit large amounts of neutrons due to the fusion reactions. fusion in progress, and will be extremely destructive to the sensitive internal poloidal field coils. This shows that rearranging the reactor setup into two or more distinct reactor configurations, for example by moving the internal poloidal field coils vertically, can generate significant improvements in reactor operating efficiency, reducing input energy costs and increasing the useful life of components.

The above mentioned technique can be implemented in accordance with the teachings of the Italian patent application n. 102020000006604, the contents of which are incorporated herein by reference.

In particular, the internal poloidal field coils S3a, S3b (and possibly also S1a-S2a, S1b-S2b), can be moved vertically in the same way as the coils 311-312, 315-316 of FIG. 3 of the Italian patent application n. 102020000006604. In greater detail, the system IA and the mechanical structure described in said Italian patent application can be advantageously used for this purpose.

Agent IA is preferably included in the aforementioned control device 400.

The mechanical structure can be a robotic mechanical structure, identified with 700 in FIG. 1. The robotic mechanical structure 700 corresponds to the robotic structure 300 of the Italian patent application no. 102020000006604.

Advantageously, the reactor 1 comprises means for moving the poloidal magnets between at least two different positions and, in particular, between a first position for the start-up of the reactor 1 and a second position for the steady-state operation of the reactor itself.

In particular, therefore, suitable handling means can be provided, substantially included in the robotic mechanical structure 700, configured to move at least one of the magnets, and preferably at least one of the poloidal magnets between a first position and a second position.

Preferably said first position can be closer to the equator EQ of the plasma than said second position. Preferably, said second position can be further away from the equator EQ of the plasma than said first position.

Advantageously, the first position can be positioned closer to the plasma when this is in a normal operating condition with respect to said second position.

Conveniently, the second position can be located far from the plasma when this is in a condition of normal operation with respect to said first position.

Conveniently, the second position may be, with respect to said first position, more protected from the neutrons emitted by the plasma in conditions of normal operation.

Conveniently, in particular, the handling means can be configured to move at least one of the poloidal magnets positioned inside the chamber 100. In particular, the handling means can be configured to move at least one of the poloidal magnets when the tokamak is activated, namely the chamber 100 is separated and isolated from the outside and/or it is at a pressure lower than the ambient one and/or the plasma is in a start-up condition and/or the plasma is in a heating condition and/or the plasma is in a normal condition fusion operation and/or the plasma is in a rundown and/or shutdown condition.

In particular, the handling means can be configured to move at least a first poloidal magnet S1a between a first position, in which it is at the same Z coordinate (Z being the vertical axis substantially corresponding to the axis of symmetry of the chamber 100) of the PXP or closer to the EQ equator than PXP and a second position where it is at a higher Z coordinate than PXP, or further from the EQ equator than PXP.

Conveniently, the present invention can also relate to a method of using a tokamak, and in particular a spherical tokamak, preferably with negative triangularity.

In particular, the method involves the following steps:
1. A start-up phase during which the gas, preferably hydrogen or its isotopes, which is present inside the chamber 100 is ionized by means of suitable electromagnetic fields to form a plasma, advantageously said ignition phase can be realized according to non-inductive processes, such as Double Null Merging (DNM), in which two plasma rings are created, one in the upper region 100a and one in the lower region 100b of the chamber 100, which are subsequently made converge;
2. A heating phase and current ramp up during which the plasma is progressively heated through the use of microwave deposit, Neutral Beam Injection (NBI), and other mechanisms such as the use of variable electromagnetic fields;
3. A normal fusion burn operation phase during which the plasma is hot enough to allow the fusion reactions, in a stable and sustainable way;
4. A Decrease and shutdown of the reactor phase.

Conveniently, said movement means can be configured to position said magnets, and preferably at least one poloidal magnet, and more preferably at least one poloidal magnet present inside the chamber 100 in said first position during said start-up/start-up phase.

Conveniently, said movement means can be configured to position said magnets, and preferably at least one poloidal magnet, and more preferably at least one poloidal magnet present inside the chamber 100 in said second position during said heating phase and current increase and/or during said phase of normal fusion burn operation.

In particular, the movement means are configured to position said first poloidal magnet S1a in said first position, and in particular at a lower Z coordinate than PXP, during the Start-up phase. In particular, the handling means are configured to position said first poloidal magnet S1a in said second position, and in particular at a coordinate Z higher than PXP during the normal operation phase.

Conveniently, the movement means can be controlled automatically by said control device, preferably on the basis of the information detected by said detection devices.

Conveniently, in a possible embodiment, the reactor is configured in such a way as to operate with plasma in positive triangularity during the start-up phase and in such a way as to operate with plasma in negative triangularity during the steady-state operating phase (in particular during the phase called “Normal fusion burn operation”).

The Applicant observes that the application of this technique is particularly advantageous in the tokamak reactor 1 described above, since the input of the divertor starts more externally with respect to the central point of the main plasma volume (plasma core), and more externally with respect to point X of the plasma, in the sense that it becomes possible to move the internal poloidal field coils vertically without having to move the divertor group itself.

In particular, unlike US2010/063344, the present solution concerns a tokamak reactor which is configured to operate with plasma in negative triangularity. Furthermore, unlike the solution described in “Coils and power supply design for the SMall Aspect Ratio Tokamak (SMART) of the University of Seville” by Manuel Agredano, the tokamak reactor according to this solution provides for the presence of a divertor which is configured to operate with plasma in negative triangularity and which includes an inlet which is located in an external support vessel (V) at a radially outermost position relative to point X (PXP) where the radially internal plasma separator leg intersects (L1) and the radially outer plasma separator leg (L2).

1. Spherical-type tokamak configured to operate with plasma in negative triangularity, comprising a chamber (100) for housing a plasma, said tokamak being configured so that, during operation, said plasma defines a profile having both in an upper region (UR) as well as in a lower region (LR) of said plasma, a radially internal plasma separator leg (L1) and a radially external plasma separator leg (L2);
wherein:
the chamber (100) comprises an upper region (100a) for receiving said upper plasma region (UR) and comprises a lower region (100b) for receiving said lower plasma region (LR),
at least one of the upper region (100a) or the lower region (100b) of the chamber (100) are equipped with at least one divertor (300) configured to operate with plasma in negative triangularity, said at least one divertor (300) comprising a divertor plate (210, 220) and divertor field coils (D1a-D6a, D1b-D6b), wherein said divertor field coils (300) being configured to drive the radially inner and radially outer plasma separator legs (L1, L2) towards the respective divertor plate (210, 220);
said at least one divertor (300) which is configured to operate with plasma in negative triangularity and which comprises an inlet which is located in an external support vessel (V) in a radially outermost position with respect to a point X (PXP) of a respective region (100a, 100b) in which, during operation, said radially inner plasma separator leg (L1) and said radially outer plasma separator leg (L2) are intended to intersect.

2. The tokamak according to claim 1, wherein the upper region (100a) and the lower region (100b) of the chamber (100) are both closed, respectively above and below, by a respective divertor plate (210, 220) and wherein each divertor comprises a respective divertor plate (210, 220).

3. The tokamak according to claim 1, wherein the divertor configured to operate with plasma in negative triangularity (300) is configured to guide the radially outer plasma separator leg (L2) such that the radially outer plasma separator leg (L2) does not intersect a vessel (V) for supporting said chamber (100), the divertor plates (210, 220) or any of the divertor field coils (D1a-D4a, D1b-D4b).

4. The tokamak according to claim 1, further comprising poloidal field coil magnets (311-316, S1a-S3a, S1b-S3b) configured to support fusion plasma having both positive and negative triangularity.

5. The tokamak according to claim 4, wherein said field coils (D1a-D4a, D1b-D4b) of the divertor (300) cooperate with said poloidal field coil magnets (311-316, S1a-S3a, S1b-S3b) to support a fusion plasma with negative triangularity.

6. The tokamak according to claim 1, wherein each of said divertor plates (210, 220) comprises:
a base plate (210.1, 220.1) having a circular profile;
a first thermo-absorbing annular projection (210.2, 220.2) extending from said base plate (210.1, 220.1) inside said chamber (100), said first thermo-absorbing annular projection (210.2, 220.2) being arranged along a first circumference having a first diameter (D1.1, D1.2);
a second thermo-absorbing annular projection (210.3, 220.3) extending from said base plate (210.1, 220.1) inside said chamber (100), said second thermo-absorbing annular projection (210.3, 220.3) being arranged along a second concentric circumference at the first circumference and having a second diameter (D2.1, D2.2) greater than said first diameter (D1.1, D1.2).

7. The tokamak according to claim 4, further comprising means for moving said poloidal field coil magnets (311-316, S1a-S3a, S1b-S3b) between at least two different positions, between a first position, during start-up of said tokamak and a second position, during full operation of said tokamak.

8. The tokamak according to claim 4, further comprising:
a control device (400), equipped with an Artificial Intelligence agent, IA, configured to manage the nuclear fusion process; and
a robotic mechanical structure (700), configured to move vertically one or more of said poloidal field coil magnets (311-316, S1a-S3a, S1b-S3b), said control device (400) also being configured to control said robotic mechanical structure (700).

9. The tokamak according to claim 8, wherein said robotic mechanical structure (700) is active on one or more internal poloidal field coils (S1a-S3a, S1b-S3b) forming part of said field coil magnets poloidal (311-316, S1a-S3a, S1b-S3b), and in particular at least on an upper and a lower internal poloidal field coil (S3a, S3b) having a larger diameter than the other internal poloidal field coils.

10. Tokamak configured to operate in a negative triangularity configuration, comprising a chamber (100) in which an upper region (100a) and a lower region (100b) are defined which are separated by an equator (EQ), at least one of said two regions (100a, 100b) has at an apex thereof a divertor (300) configured to be used with a plasma maintained in a condition of negative triangularity, each divertor (300) comprising a divertor plate (210, 220) and at least one magnet, (D1a-D6a, D1b-D6b), and being configured to generate a divertor field, and inside said chamber (100) the gas to be ionized and/or a plasma obtained from said gas, called plasma defining during operation:
an upper region (UR)
a lower region (LR),
a radially internal plasma separator leg (L1)
a radially external plasma separator leg (L2)
a point X (PXP), in each of the two regions (UR, LR) in which said radially internal plasma separator leg (L1) and said radially external plasma separator leg (L2) intersect
a negative triangularity profile,
said at least one magnet (D1a-D6a, D1b-D6b) being configured to guide the radially internal and radially external plasma separator legs (L1, L2) towards a respective divertor plate (210, 220), and said divertor (300) has an entrance located in an external support vessel (V) in a more external position with respect to said point X (PXP) of the plasma.

11. The tokamak according to claim 1, wherein the tokamak is configured to form a plasma which, under normal operating conditions, has a larger surface in correspondence to the region where the magnetic field is most intense (HFS).

12. The tokamak according to claim 1, wherein at least one of said divertors (300) is a super-X divertor by negative triangularity.

13. The tokamak according to claim 1, wherein the tokamak does not have any solenoid.

14. (canceled)

15. The tokamak according to claim 1, wherein the tokamak is configured to be started by means of “Double Null Merging” (DNM).

16. The tokamak according to claim 1, wherein the tokamak further comprises one or more detection devices (S1-S5) associated with said chamber (100).

17.-19. (canceled)

20. The tokamak according to claim 1, wherein the tokamak comprises a control device (400) configured to control the operation of the tokamak itself on the basis of the readings made by said detection devices.

21. The tokamak according to claim 1, wherein the tokamak is configured to generate a plasma in which said PXP is located in an innermost position with respect to the center of the plasma.

22. The tokamak according to claim 1, wherein the tokamak is configured to generate a plasma which has a larger surface directed towards the inside of said chamber (100).

23. The tokamak according to claim 1, wherein the tokamak comprises mechanized handling means configured to move at least one magnet between a first and a second position.

24.-26. (canceled)

27. The tokamak according to claim 7, wherein said movement means are configured to move at least a first poloidal magnet (S1a) between a first position, in which it is at the same Z coordinate of the PXP or closer to EQ with respect to PXP and a second position where it is at a Z coordinate higher than PXP, or farther from the equator than PXP.

28.-32. (canceled)
